(19) United States
(12) Patent Application Publication
(10) Pub. No.: US 2002/0108818 A1
(43) Pub. Date: Aug. 15, 2002

(54) Disk brake

(76) Inventors: Yuzo Imoto, Chita-gun (JP); Takahisa Yokoyama, Anjo-city (JP); Takashi Murayama, Kariya-city (JP)

Correspondence Address: LAW OFFICE OF DAVID G POSZ, 2000 L STREET, N.W., SUITE 200, WASHINGTON, DC, 20036, US

(21) Appl. No.: 10/073,062

(22) Filed: Feb. 12, 2002

(30) Foreign Application Priority Data
Feb. 15, 2001 (JP) 2001-39000
Dec. 21, 2001 (JP) 2001-389308

(51) Int. Cl. F16D 55/08

(52) U.S. Cl. 188/72.7

(57) ABSTRACT

In a disk brake, a first surface of a wedge member is in line contact via a first roller bearing with a surface of the piston and a second surface of the wedge member is also in line contact via a second roller bearing with a surface of the guide member. Each of the first surface of the wedge member and the surface of the piston is perpendicular to a piston axis and each of the second surface of the wedge member and the surface of the guide member is inclined by a given angle to the piston axis. When a drive unit moves the wedge member substantially perpendicularly to the piston axis, the piston moves axially and presses a frictional material against a disk. Since force transmitted from the wedge member to the piston acts parallel to the piston axis with a less moment in a direction of pressing the piston against a wall surface of the cylindrical bore so that the piston moves smoothly.

### CROSS REFERENCE TO RELATED APPLICATION

This application is based upon and claims the benefit of priority of Japanese Patent Applications No. 2001-39000 filed on Feb. 15, 2001 and No. 2001-389308 filed on Dec. 21, 2001, the contents of which are incorporated herein by reference.

### BACKGROUND OF THE INVENTION

1. Field of the Invention

The present invention relates to a disk brake having a rotary disk and frictional material to be pressed against the rotary disk by a piston for braking, in particular, applicable to a vehicle.

2. Description of Related Art

A disk brake disclosed in JP-A-62-251533, as shown in FIG. 30, has a piston 5 whose one axial end surface faces to a frictional material 3 and whose the other axial end surface 5z is inclined to a plane perpendicular to an axial direction thereof, a ball 50 in contact with the other axial end surface 5z, and a hydraulic drive unit 9 having a rod 51 and an annular groove 52 for moving the ball 50 perpendicularly to the axial direction of the piston 5. A driving force of the hydraulic drive unit 9 is converted via the ball 50 and the other axial end surface 5z to a component of force causing the piston 5 to move toward the frictional material 3. The inclination angle θ of the other axial end surface 5z is less than 45° so that the component of force of pressing the frictional material 3 is larger than the driving force of the drive unit 9. Accordingly, the force of pressing the frictional material is larger, compared with that of the conventional other type of disk brake in which hydraulic force acts directly on the piston.

However, the disk brake mentioned above has a drawback that a movement of the piston 5 is not always smooth.

Since the other axial end surface 5z of the piston 5 is not perpendicular to the piston axis, another component of force to be transmitted via the ball 50 from the rod 51 causes the piston 5 to press against a wall surface of a cylindrical bore 2a so that a frictional resistance between the piston 5 and the wall surface of the cylindrical bore 2a is larger, thus, adversely affecting on the smooth movement of the piston 5.

Further, when the drive unit 9 is driven, a moment acts on the piston 5 in a direction of pressing the piston 5 against the wall surface of the cylindrical bore 2a when a contact point between the ball 50 and the other axial end surface 5z of the piston 5, which moves in a right direction in FIG. 30, is at a position offset from the piston axis.

Moreover, in case the contact point between the piston 5 and the ball 50 or between the ball 50 and the rod 51 is a single point, a load concentrating on the contact point is too heavy.

As shown in FIG. 31, another conventional disk brake disclosed in JP-A-62-127533 has a wedge member 61 and a roller 62 arranged between an inclined surface 5z of a piston 5 and an inclined surface 60a of a guide member 60. When a control shaft 65 rotates in a given direction via a motor shaft 64 by an electric motor 63 as a drive unit, the wedge member 61 and the roller 62 move relative to the piston 5 and the guide member 60 so that the inclined surface 5z moves away from the inclined surface 60a. Accordingly, the piston 5 moves toward a frictional material.

However, this disk brake still has a drawback that a movement of the piston 5 is not always smooth due to the frictional resistance between the piston 5 and a wall surface of a cylindrical bore 2a. A component of force to be transmitted via the roller 62 from the wedge member 61 to the piston 5 acts in a direction of pressing the piston 5 against the wall surface of the cylindrical bore 2a because of the inclined surface 5z.

Further, when a contact point between the roller 62 and the piston 5 moves along the inclined surface 5z and is at a position offset from the piston axis, there occurs a moment of pressing the piston 5 against the wall surface of the cylindrical bore 2a. Even if a plural rollers 62 are provided, the moment will occur unless the contact points between the rollers 62 and the piston 5 are at the opposite sides of the piston axis so that the component forces transmitted to the piston via the respective rollers are substantially counterbalanced with each other.

### SUMMARY OF THE INVENTION

An object of the invention is to provide a disk brake in which a piston moves smoothly.

Another object of the invention is to provide a disk brake having a longer lifetime.

To achieve any of the above objects, the disk brake has a disk to be rotated from outside, a frictional material whose one surface faces to the disk, a piston, whose axial end surface is connected to the other surface of the frictional material, movable in a bore, a guide member disposed on an opposite side of the disk with respect to the piston, a wedge member sandwiched between the piston and the guide member, and a drive unit for moving the wedge member substantially perpendicularly to an axis of the piston, while allowing the wedge member to float in an axial direction of the piston.

With the disk brake mentioned above, a side surface of the wedge member is in line contact with plural positions of the other axial end surface of the piston that are dispersed on opposite sides of an axis of the piston and the other side surface of the wedge member is in line contact with a surface of the guide member. Further, a contact surface between the piston and the wedge member is a plane perpendicular to an axis of the piston and a contact surface between the wedge member and the guide member is a plane being inclined by a given angle to the axis of the piston.

As the wedge member and the piston are in line and plural position contact with each other and the force to be transmitted to the piston from the wedge member are dispersed on opposite sides of the piston axis, load does not concentrate on a single point.

Accordingly, when the drive unit drives the wedge member, the piston moves axially and presses the frictional material against the disk. Since force to be transmitted from the wedge member to the piston via the contact surface therebetween acts substantially only in an axial direction of the piston with a less moment in a direction of pressing the piston against a wall surface of the bore so that the piston moves smoothly.

As another aspect of the present invention, the disk brake has a disk to be rotated from outside, a frictional material whose one surface faces to the disk, a piston, whose axial end surface is connected to the other surface of the frictional material, movable in a bore, a guide member disposed on an opposite side of the disk with respect to the piston, an arc shaped wedge member sandwiched between the piston and the guide member, and a drive unit for rotating the wedge member about a rotating center that is positioned on an extended line of an axis of the piston, while allowing the wedge member to float in an axial direction of the piston.

With the disk brake mentioned above, one side surface of the wedge member being in line contact with plural positions of the other axial end surface of the piston that are dispersed on opposite sides of an axis of the piston and the other side surface of the wedge member is in line contact with a surface of the guide member. Further, a contact surface between the piston and the wedge member is an arc surface whose curvature is substantially same as that of the wedge member and whose curvature center is positioned on the extended line of the axis of the piston and a contact surface between the wedge member and the guide member is an arc surface whose curvature center is located on a line being inclined by a given angle to the axis of the piston.

Accordingly, when the wedge member is driven, the piston moves axially and presses the frictional material against the disk. Since forces to be transmitted from the wedge member to the piston via the contact surface therebetween are dispersed on the opposite sides of the piston axis so that component forces acting in a direction of pressing the piston against the wall surface of the bore are substantially counterbalanced with each other so that the piston moves smoothly.

As a further aspect of the present invention, a disk brake has a disk to be rotated from outside, a frictional material whose one surface faces to the disk, a bore, a slide bearing provided in the bore, a piston, whose axial end surface is connected to the other surface of the frictional material, movable via the slide bearing in the bore, a guide member disposed on an opposite side of the disk with respect to the piston, a wedge member sandwiched between the piston and the guide member, and a drive unit for moving the wedge member along a contact surface between the piston and the wedge member and along a contact surface between the wedge member and the guide member so as to make the wedge member a relative movement to the piston and the guide member.

With the disk brake mentioned above, one side surface of the wedge member is in line contact with plural positions of the other axial end surface of the piston that are dispersed on opposite sides of an axis of the piston and the other side surface of the wedge member is in line contact with a surface of the guide member. Further, a length of the wedge member in an axial direction of the piston from the contact surface between the piston and the wedge member to the contact surface between the wedge member and the guide member varies in a direction perpendicular to the piston axis. Accordingly, when the wedge member is driven, the piston is moved in a direction of pressing the frictional material against the disk. Since the slide bearing is provided in the bore, frictional resistance between the piston and the wall surface of the bore is limited, even if there exist component forces in a direction of pressing the piston against the wall surface of the bore, so that piston moves smoothly.

In the disk brakes mentioned above, it is preferable that a side surface of the wedge member or the other axial end surface of the piston is provided with a roller bearing having a plurality of rollers or at least two roller bearings each having a roller and the rollers or the roller are or is in contact with other of the other axial end surface of the piston or the side surface of the wedge member that constitutes the contact surface between the piston and the wedge member.

It is further preferable that the other side surface of the wedge member or the surface of the guide member is also provided with a roller bearing having a plurality of rollers or at least a roller bearing having a roller and the rollers or the roller are or is in contact with the surface of the guide member or the other side surface of the wedge member that constitutes the contact surface between the wedge member and the guide member.

The roller bearing may move relative to the piston and the wedge member or relative to the wedge member and the guide member or may be fixed to the piston, wedge member or the guide member.

If the roller bearings are fixed to the wedge member, it is preferable that an outer circumference of the roller of the roller bearing on a side of the guide member is in contact with at least an outer circumference of the roller of the roller bearing on a side of the piston. Since reaction force acting on the roller bearing on a side of the piston counterbalances with reaction force acting on the roller bearing on a side of the guide member, force affecting on positions where the roller bearings are fixed to the wedge member.

On the other hand, if the roller bearing is arranged to move, it is preferable to provide a displacement transmission device such as a pinion and rack gears, a friction ring or sheet and a link for forcing the roller bearing to move relative to the other axial end surface of the piston and the side surface of the wedge member together with the movement of the wedge member.

### BRIEF DESCRIPTION OF THE DRAWING

Other features and advantages of the present invention will be appreciated, as well as methods of operation and the function of the related parts, from a study of the following detailed description, the appended claims, and the drawings, all of which form a part of this application. In the drawings:

FIG. 1 is a cross sectional view of a disk brake according to a first embodiment of the present invention;

FIG. 2 is a cross sectional view taken along a line II-II of FIG. 1;

FIG. 3 is a partly enlarged view of a wedge member 8 and roller bearings 14, 15 of FIG. 1;

FIG. 4 is a cross sectional view of a disk brake according to a second embodiment of the present invention;

FIG. 5 is a cross sectional view taken along a line V-V of FIG. 4;

FIG. 6 is a cross sectional view of a disk brake according to a third embodiment of the present invention;

FIG. 7 is a cross sectional view of a disk brake according to a fourth embodiment of the present invention;

FIG. 8 is a cross sectional view taken along a line VII-VII of FIG. 7;

FIG. 9 is a partial view of a disk brake according to a fifth embodiment of the present invention;

FIG. 10 is a partial view of a disk brake according to a sixth embodiment of the present invention;

FIG. 11 is a cross sectional view taken along a line XI-XI of FIG. 10;

FIG. 12 is a partial view of a disk brake according to a seventh embodiment of the present invention;

FIG. 13 is a cross sectional view taken along a line XIII-XIII of FIG. 12;

FIG. 14 is a partial view of a disk brake according to an eighth embodiment of the present invention;

FIG. 15 is a cross sectional view taken along a line XV-XV of FIG. 14;

FIG. 16 is a partial view of a disk brake according to a ninth embodiment of the present invention;

FIG. 17 is a partial view of a disk brake according to a tenth embodiment of the present invention;

FIG. 18 is a partial view of a disk brake according to an eleventh embodiment of the present invention;

FIG. 19 is a partial view of a disk brake according to a twelfth embodiment of the present invention;

FIG. 20 is a perspective view of a pinion gear of FIG. 19;

FIG. 21 is a partial view of a disk brake according to a thirteenth embodiment of the present invention;

FIG. 22 is a partial view of a disk brake according to a fourteenth embodiment of the present invention;

FIG. 23 is a partial view of a disk brake according to a fifteenth embodiment of the present invention;

FIG. 24 is a partial view of a disk brake according to a sixteenth embodiment of the present invention;

FIG. 25 is a partial view of a disk brake according to a seventeenth embodiment of the present invention;

FIG. 26 is a partial view of a disk brake according to an eighteenth embodiment of the present invention;

FIG. 27 is a cross sectional view taken along a line XVII-XVII of FIG. 26;

FIG. 28 is a partial view of a disk brake according to a nineteenth embodiment of the present invention;

FIG. 29 is an exploded perspective view of a roller and a link of FIG. 28;

FIG. 30 is a partially broken out view of a conventional disk brake as a prior art; and

FIG. 31 is a partially broken out view of another conventional disk brake as a prior art.

### DETAILED DESCRIPTION OF THE PREFERRED EMBODIMENTS

(First Embodiment)

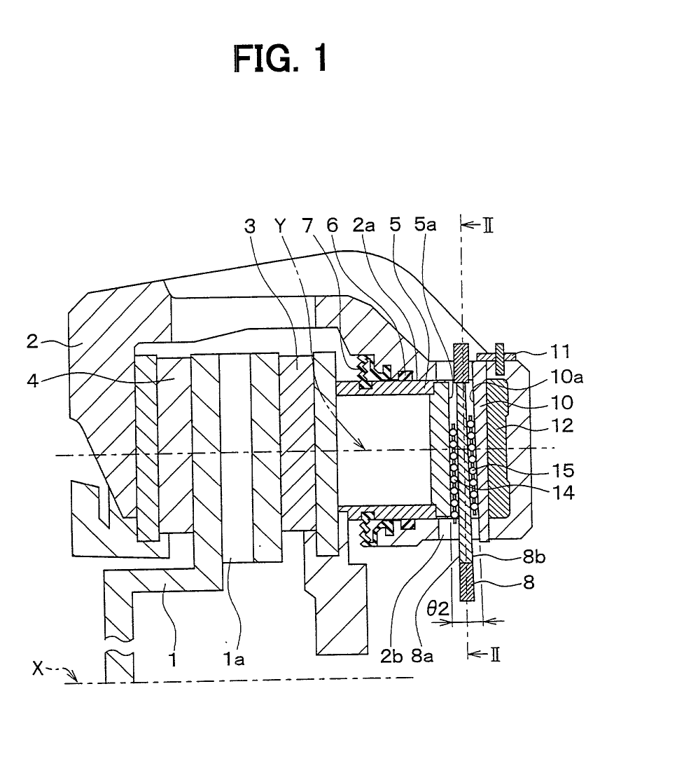

A first embodiment of the present invention is described with reference to FIGS. 1 to 3.

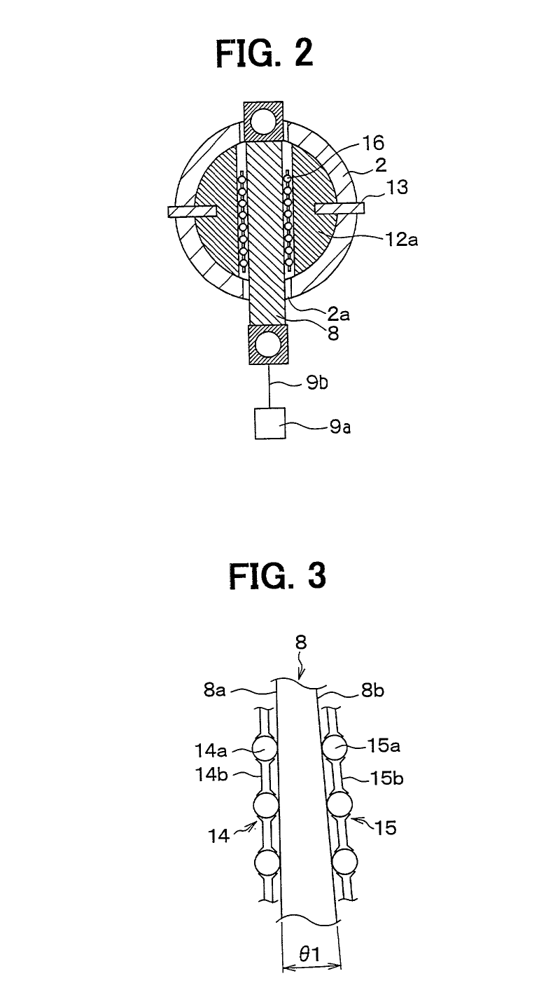

As shown FIGS. 1 and 2, a disk 1 rotates about a disk axis X together with a wheel (not shown). The disk 1 is provided with a ventilation hole 1a. A caliper 2, whose cross sectional view is formed in one side opened square shape, is arranged in a vicinity of an outer circumference of the disk 1 so as to stride over the outer circumference of the disk 1. The caliper 2 is attached to a vehicle body so as to be movable in a direction of the disk axis X.

First and second frictional materials 3 and 4 are disposed to face to opposite side surfaces of the disk 1 in a direction of the disk axis X, respectively. The caliper 2 holds the second frictional material 4 so as to move in a direction of the disk axis X. The first and second frictional materials are pressed against the disk 1 for performing a braking operation. The caliper 2 is provided on a side of the first frictional material 3 with respect to the disk 1 with a cylinder bore 2a, in which a cylindrical piston 5 is slidably accommodated. Opposite end surfaces of the piston 5 in a direction of a piston axis Y are formed perpendicularly to the piston axis Y. One end surface of the piston 5 opposes to and holds the first frictional material 3. The piston 5 can move in the direction of the piston axis Y that is parallel to the disk axis X.

An elastic seal ring 6 is housed in a groove provided in an inner wall of the cylinder bore 2a, so an inner circumferential surface of the elastic seal ring 6 is in close but slidable contact with an outer circumference of the piston 5. A dust seal 7 is provided between the inner wall of the cylindrical bore 2a and the outer circumference of the piston 5.

A wedge shaped plate member 8 (hereinafter called wedge member 8), which is disposed on a side of the other end surface 5a of the piston 5 (hereinafter called a wedge member side surface 5a), is driven by a drive unit 9 having a hydraulic unit 9a and a link mechanism 9b so that the wedge member 8 is moved along the wedge member side surface 5a substantially perpendicularly to the piston axis Y, while being allowed to float in a direction of the piston axis Y. The caliper 2 is provided with two through-holes 2b through which the cylindrical bore 2a communicates with outside. The wedge member 8 is driven and moved through one of the through-holes 2b by the drive unit 9. Thickness of the wedge member 8 in a direction of the piston axis Y varies along a longitudinal direction of the wedge member 8. The wedge member 8 is tapered at an angle θ1 (refer to FIG. 3) so as to narrow the thickness thereof continuously from a longitudinal end thereof on a side of the drive unit 9 toward the other longitudinal end thereof (upward in FIG. 1).

A guide member 10 is disposed on a side opposite to the piston 5 with respect to the wedge member 8. A longitudinally extending side surface 10a of the guide member 10 on a side of the wedge member (hereinafter called wedge member side surface 10a) is positioned at an angle θ2 to the wedge member side surface 5a of the piston 5. The angle θ2 is substantially equal to the angle θ1. The guide member 10 is fixed to the caliper 2 by a stopper 11 that prevents the guide member 10 from dropping out of the caliper 2.

A spacer 12 is disposed between the guide member 10 and a bottom of the cylindrical bore 2a. As shown in FIG. 2, the spacer 12 is provided with two protruding portions 12a extending toward the piston 5 so as to hang over opposite upper and lower side surfaces of the wedge member 8 and the guide member 10. The spacer 12 is fixed to the caliper 2 by pins 13 that prevent the rotation thereof (refer to FIG. 3).

A first roller bearing 14 is disposed between the wedge member side surface 5a of the piston 5 and a surface 8a of the wedge member 8 on a side of the piston 5 (hereinafter called piston side surface 8a). The first roller bearing 14 has cylindrical or column shaped rollers 14a that roll according to the movement of the wedge member 8. Further, a second roller bearing 15 is disposed between a surface 8b of the wedge member 8 on a side of the guide member 10 (hereinafter called guide member side surface 8b) and the wedge member side surface 10a of the guide member 10. The second roller bearing 15 has cylindrical or column shaped rollers 15a that roll according to the movement of the wedge member 8. The first and second roller bearing 14 or 15 is of well known type in which the rollers 14a or 15a are rotatably held by a holder 14b or 15b.

A third roller bearing 16 is disposed between each of the two protruding portions 12a and the wedge member 8. The third roller bearing 16 has also rollers that roll according to the movement of the wedge member 8 and has a construction similar to the first or second roller bearing 14 or 15.

The piston 5, the wedge member 8 and the guide member 10 are assembled in such a manner that the wedge member side surface 5a of the piston 5 is parallel to the piston side surface 8a of the wedge member 8 and the guide member side surface 8b of the wedge member 8 is parallel to the wedge member side surface 10a of the guide member 10.

An operation of the disk brake mentioned above is described below.

When master cylinder pressure produced according to an operation of a brake pedal (not shown) is transmitted to the drive unit 9, the wedge member 8 is forced to move upward in FIG. 1 by a driving force of the drive unit 9. Then, the first, second and third roller bearings 14, 15 and 16 move so as to follow the movement of the wedge member 8, while the rollers of the first to third roller bearings 14 to 16 roll. According to the upward movement of the wedge member 8, a distance between the piston 5 and the guide member 10 in a direction of the piston axis Y becomes larger since the thickness of the wedge member 8 varies in the moving direction thereof. The driving force of the drive unit 9 acting on the wedge member 8 is converted into a component of force perpendicular to the guide member side surface 8b of the wedge member 8, which acts on the guide member 10 via the second roller bearing 15, since the guide member side surface 8b of the wedge member 8 and the wedge member side surface 10b of the guide member 10 are tapered. The component force presses the guide member 10 in a direction opposite to the piston 5. Since the guide member 10 is fixed to the caliper 2 so that the guide member 10 can not move relative to the caliper 2 in a direction of the piston axis Y, the wedge member 8 is displaced in a direction of the piston axis Y relative to the guide member 10 by a reaction force of the component force acting on the guide member 10. Accordingly, the piston 5 moves toward the disk 1, so the first frictional material 3 is pressed against the disk 1.

After the first frictional material 3 comes in contact with the disk 1 and the wedge member 8 can not move toward the disk 3 any more, the component force acting on the guide member 10 according to the longitudinal movement of the wedge member 8 causes the caliper 2 to move so as to bring the second frictional material 4 close to the disk 1, so the second frictional material 4 is pressed against the disk 1.

As mentioned above, the first and second frictional materials 3 and 4 are pressed against the disk 1, so a rotation of the disk 1 is suppressed for braking the vehicle.

According to the first embodiment, since the wedge member side surface 5a of the piston 5 and the piston side surface 8a of the wedge member 8 are perpendicular to the piston axis Y, respectively, a direction of the force acting on the piston 5 via the first roller bearing 14 from the wedge member 8 is parallel to the piston axis Y. Accordingly, there exists no component force acting on the piston 5 in a direction of pressing the piston 5 against a wall surface of the cylinder bore 2a so that the piston 5 can move smoothly.

Further, the first roller bearing 14 disposed between the wedge member side surface 5a of the piston 5 and the piston side surface 8a of the wedge member 10 has a plurality of the rollers 14a that are arranged on opposite sides of the piston axis Y and roll according to the movement of the wedge member 8. Accordingly, the force to be transmitted to the piston 5 via the first roller bearing 14 according to the movement of the wedge member 10 is dispersed on the respective rollers 14a so that the force acts uniformly on the wedge member side surface 5a of the piston 5, so a moment of pressing the piston 5 against the wall surface of the cylinder bore 2a is limited, resulting in moving the piston 5 smoothly.

Due to a synergistic effect of two advantages as mentioned above, that is, one is no existence of the component force of pressing the piston 5 against the wall surface of the cylindrical bore 2a and the other is the limited moment of pressing the piston 5 against the wall surface of the cylinder bore 2a, a frictional resistance between the piston 5 and the wall surface of the cylindrical bore 2a is distinctly small so that the movement of the piston 5 is remarkably smooth.

Further, the rollers 14a and 15a of the fist and second roller bearings 14 and 15 come in line contact with a plurality of positions of the wedge member side surface 5a of the piston 5, the piston side surface 8a of the wedge member 8, the guide member side surface 8b of the wedge member 8 and the wedge member side surface 10a of the guide member 10, respectively. Accordingly, as the stresses are dispersed on the respective rollers, there hardly remains a trace of pressure spot on the surfaces 5a, 8a, 8b and 10a and the rollers 14a and 15a show smooth rolling. As the rollers 14a and 15a roll together with the movement of the wedge member 8, the frictional resistance between each of the rollers 14a and 15a and each of the surfaces 5a, 8a, 8b and 10a is limited.

Moreover, since each of the taper angle θ1 of the wedge member 8 and the taper angle θ2 of the guide member 10 is set to less than 45 degrees, the force for pressing the first and second frictional materials 3 and 4 against the disk 1 is larger than the driving force of the drive unit 9 for moving longitudinally the wedge member 8. Accordingly, the first and second frictional materials 3 and 4 can be pressed against the disk 1 with a hydraulic pressure of the drive unit 9 smaller than that of the conventional disk brake in which the hydraulic pressure is directly applied to the piston, thereby achieving a compact disk brake without using a hydraulic booster incorporated in the conventional disk brake.

(Second Embodiment)

A disk brake according to second embodiment has first and second roller bearings 20 and 21 whose rollers circulate along a closed loop path instead of the first and second roller bearings 14 and 15 of the first embodiment.

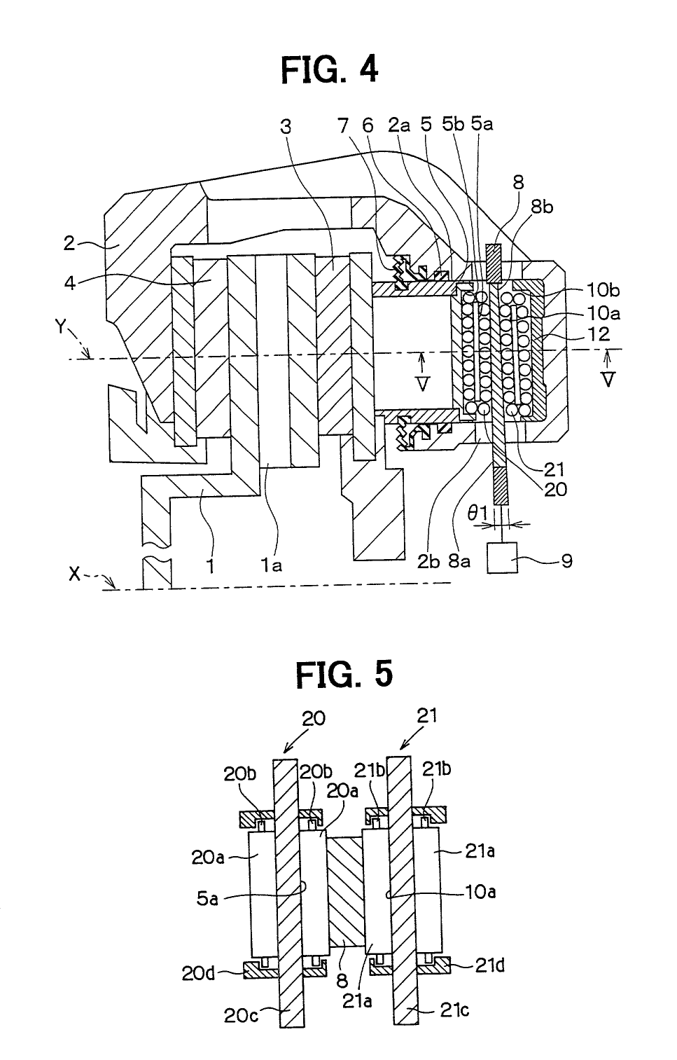

The first and second roller bearings 20 and 21 are described with reference to FIGS. 4 and 5. Each of a plurality of cylindrical or column shaped rollers 20a or 21a is provided at opposite axial ends thereof with cylindrical projections 20b or 21b. The plurality of rollers 20a or 21a are arranged on and around a plate shaped orbit base 20c or 21c . A pair of side plates 20d or 21d , which are assembled to the orbit base 20c or 21c, hold the cylindrical projections 20b or 21b so that the rollers 20a or 21a move, while rolling, along and around the orbit base 20c or 21c not to depart therefrom.

The first roller bearing 20 is positioned between the piston 5 and the wedge member 8 and fixed to the piston 5, while being partly accommodated in a recess 5b of the piston 5. A surface of the orbit base 20c on a side of the wedge member 8, with which a plurality of rollers 20a are in contact, constitutes the wedge member side surface 5a of the piston 5 that is perpendicular to the piston axis Y. The plurality of the rollers 20a in contact with the orbit plate 20c are also in contact with the piston side surface 8a of the wedge member 8 that is perpendicular to the piston axis Y.

The second roller bearing 21 is positioned between the wedge member 8 and the guide member 10 and fixed to the guide member 10, while being partly accommodated in a recess 10b of the guide member 10. A surface of the orbit base 21c on a side of the wedge member 8, with which a plurality of rollers 21a are in contact, constitutes the wedge member side surface 10a of the guide member 10 that is tapered to the piston side surface 8a of the wedge member 8 and parallel to the guide member side surface 8b of the wedge member 8. The plurality of the rollers 21a in contact with the orbit base 21c are also in contact with the guide member side surface 8b of the wedge member 8. A tapered angle of the surface of the orbit base 21c on a side of the wedge member 8 to a plane perpendicular to the piston axis Y is same as the tapered angle θ1 of the wedge member 8.

When the drive unit 9 drives the wedge member 8, the rollers 20a or 21a circulate, while rolling, on and around the orbit base 20c or 21c via the recess 5b or 10b along the closed loop path defined by the orbit base 20c or 21c and the pair of side plates 20d or 21d. According to the axial movement of the wedge member 8, the first and second frictional materials 3 and 4 are pressed against the disk 1, as described in the first embodiment.

The disk brake according to the second embodiment has the same advantages as the first embodiment. That is, because of no existence of the component force of pressing the piston 5 against the wall surface of the cylindrical bore 2a and also the limited moment of pressing the piston 5 against the wall surface of the cylinder bore 2a, a frictional resistance between the piston 5 and the wall surface of the cylindrical bore 2a is distinctly small so that the movement of the piston 5 is remarkably smooth.

(Third Embodiment)

A disk brake according to third embodiment has a wedge member 30 to be driven along a circle by the drive unit 9 instead of the wedge member 8 to be driven longitudinally as shown in the first embodiment.

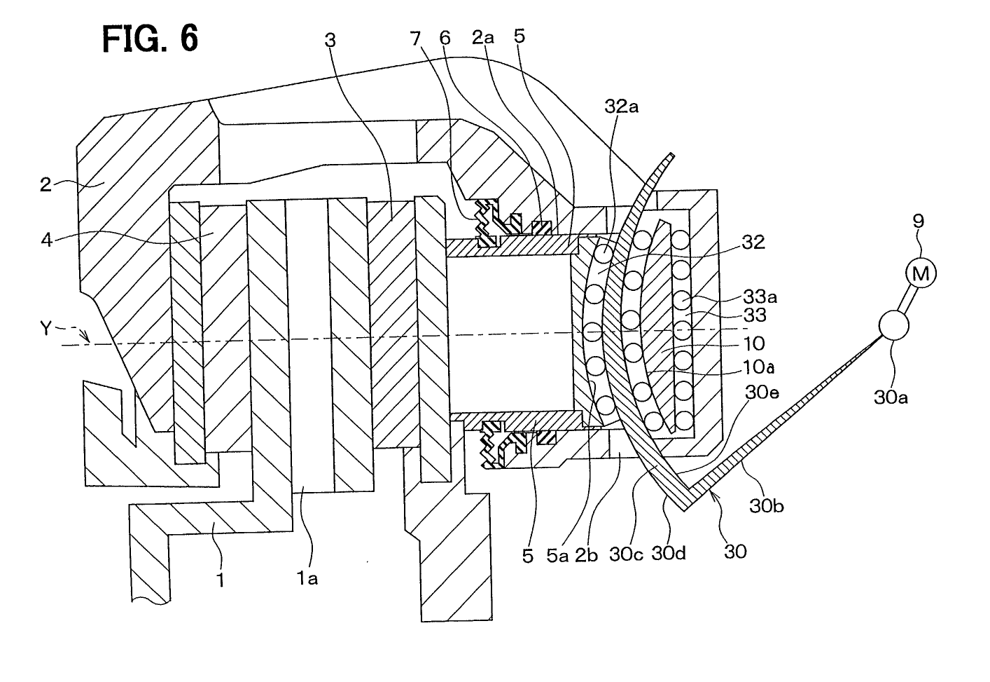

As shown in FIG. 6, the wedge member 30 rotates about a holding shaft 30a positioning in an extended line of the piston axis Y as a fulcrum. The wedge member 30 is composed of an arm whose one end is connected to the holding shaft 30a and an arc shaped wedge element 30 connected to the other end of the arm 30b. The drive unit has a mechanism that allows the wedge member 30 to move relative to the caliper 2 in a direction of the piston axis Y, while the wedge member rotates.

The holding shaft 30a is connected to a drive unit 9 composed of an electric motor and a speed reduction device. The drive unit 9 drives to rotate the wedge member 30.

A piston side surface 30d of the wedge element 30c is formed in a shape of an arc that is a part of a circle whose center is at a position of the holding shaft 30a. An opposite piston side surface 30e of the wedge element 30c is formed in a shape of an arc that is a part of a circle whose center is not at a position of the holding shaft, that is, not on the extended line of the piston axis Y but on a line crossing at a given angle to the piston axis Y. Thickness of the wedge element 30c in a direction of the piston axis Y continuously increases when the wedge member 30 rotates in a clockwise direction.

A wedge member side surface 5a of the piston 5 is formed in a shape that is an arc whose curvature is same as that of the piston side surface 30d of the wedge element 30c and substantially symmetric with respect to the piston axis Y (whose curvature center is shifted by a given distance or by a diameter of a roller 32a to be mentioned below from that of the piston side surface 30d of the wedge element 30c on the extended line of the piston axis Y).

A wedge member side surface 10a of the guide member 10 is formed in a shape of an arc whose curvature is same as that of the opposed piston side surface 30e of the wedge element 30c and whose curvature center is shifted by a given distance (a diameter of a roller 33a to be mentioned below) from that of the opposite piston side surface 30e of the wedge element 30c on the line crossing at the given angle to the piston axis Y. The guide member 10 is fixed to the caliper 2 with a space between the bottom of the cylindrical bore 2a and an opposed wedge member side surface of the guide member 10.

An arc shaped first roller bearing 32 is disposed between the piston 5 and the wedge element 30c. The arc shaped roller bearing 32 is provided with a plurality of cylindrical or column shaped rollers 32a. A circulation-type second roller bearing 33 is disposed between the wedge element 30c and the guide member 10 and between the guide member 10 and the bottom of the cylindrical bore 2a, so the cylindrical or column shaped rollers 33a circulate along a closed loop path around the guide member 10 serving as the orbit base as shown in the second embodiment.

When the drive unit 9 drives to rotate the wedge member 30 clockwise in FIG. 6 so that the rollers 32a and 33a roll, the rollers between the wedge element 30c and the guide member is pressed in a direction opposite to the piston 5, since the thickness of the wedge element 30c in a direction of the piston axis Y varies. However, as the guide member 10 can not move relative to the caliper 2, a reaction force of the force applied to the caliper 2 via the second roller bearing 33 causes the wedge member 30 to move toward the piston 5, so the piston 5 moves toward the disk 1 and, then, the first frictional material is pressed against the disk 1.

After the first frictional material comes in contact with the disk 1, the force acting on the second roller bearing 33 causes the caliper 2 to move so as to bring the second frictional material 4 close to the disk 1 so that the second frictional material 4 is pressed against the disk 1.

According to the third embodiment, component forces acting on the piston 5 via the first roller bearing 32 in a direction of pressing the piston 5 against a wall surface of the cylinder bore 2a on opposite sides of the piston axis Y are equal and counterbalanced with each other so that the piston 5 can move smoothly.

(Fourth Embodiment)

A disk brake according to fourth embodiment has a slide bearing on which the piston slides in the cylindrical bore.

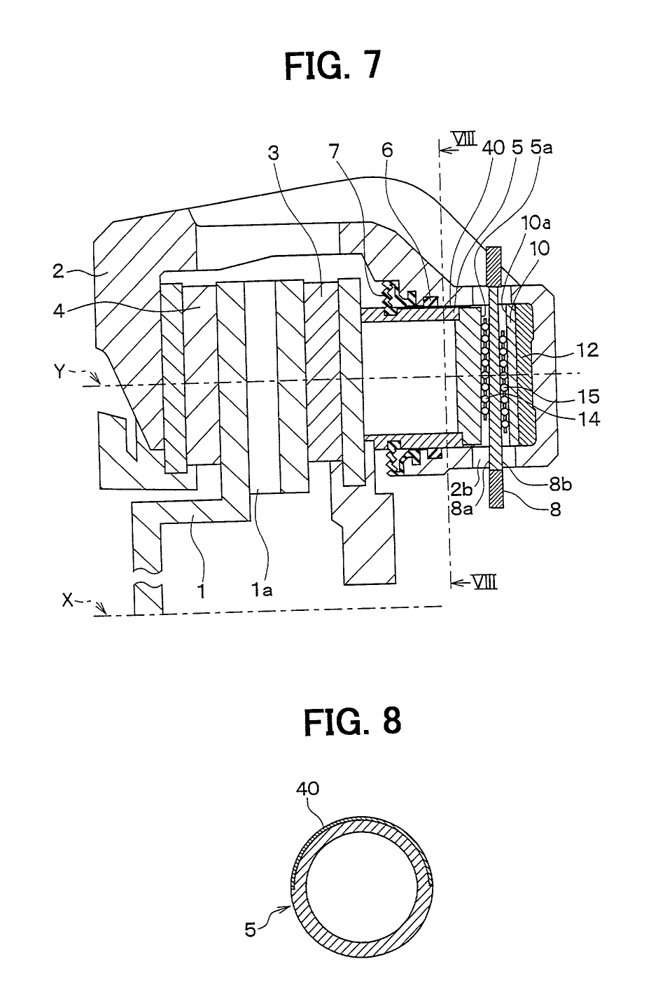

As shown in FIGS. 7 and 8, a piston 5 according to the fourth embodiment has the wedge member side surface 5a that is tapered at a given angle to a plane perpendicular to the piston axis Y. Accordingly, the piston 5 is likely to be pressed against the inner wall of the cylindrical bore 2a due to the component force transmitted thereto from the wedge member 8.

The inner wall of the cylindrical bore 2a is provided at a position against which the outer circumference of the piston 5 is pressed with a semi-cylindrical or cylindrical slide bearing 40. The slide bearing 40 serves to decrease a frictional resistance between the inner wall of the cylinder bore 2a and the piston 5 so that the piston 5 can move smoothly.

The piston side surface 8a of the wedge member 8 is tapered at the same angle as that of the wedge member side surface 5a of the piston 5. The guide side surface 8b of the wedge member 8 and the wedge member side surface 8b of the guide member 10 is tapered or parallel to a plane perpendicular to the piston axis Y. The other structure of the fourth embodiment is similar to that of the first embodiment.

Further, the slide bearing 40 may be provided in the cylindrical bore 2a, unless the wedge member side surface 5a of the piston 5 in the third embodiment is substantially symmetric with respect to the piston axis Y. In this case, the slide bearing 40 serves to decrease a frictional resistance between the inner wall of the cylinder bore 2a and the piston 5 so that the piston 5 can move smoothly.

(Fifth Embodiment)

A disk brake according to fifth embodiment has radial bearings 70 provided in the piston 5 and the guide member 10 instead of the first and second roller bearings 14 and 15 of the first embodiment.

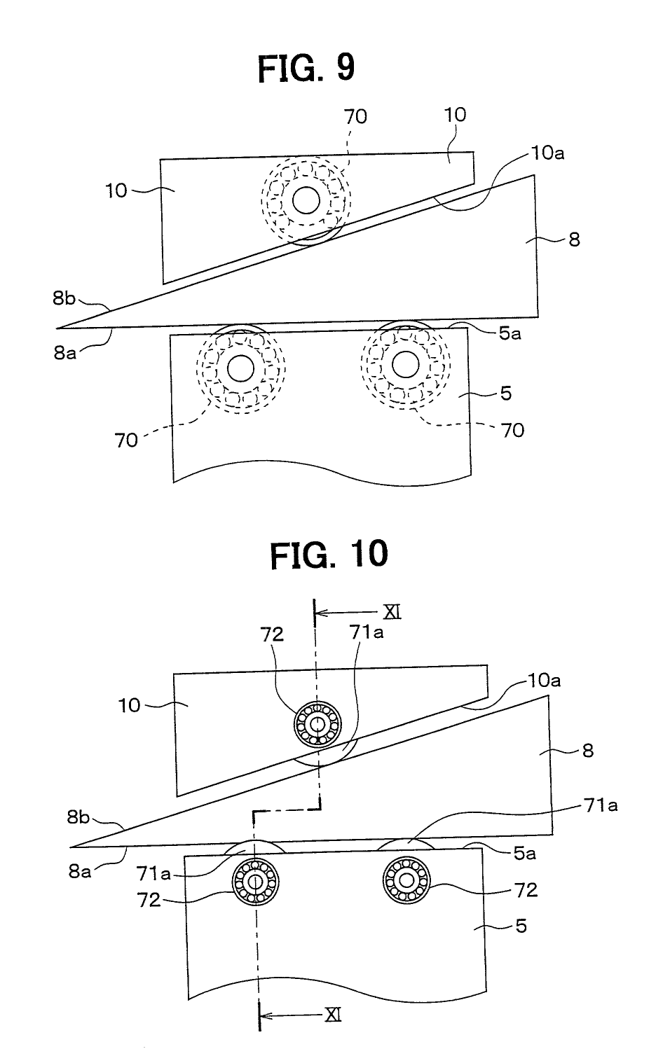

As shown in FIG. 9, two radial bearings 70 and one radial bearing 70 are fixed to and held by the piston 5 and the guide member 10, respectively. Each of the radial bearings 70, which is of well known type, has a cylindrical inner race, a cylindrical outer race and a plurality of balls or rollers between the inner and outer races.

Each inner race of the two radial bearings 70 held by the piston 5 is fixed to the piston 5 and each outer race thereof is in contact with the piston side surface 8a of the wedge member 8. The inner race of the one radial bearing 70 held by the guide member 10 is fixed to the guide member 10 and the outer race thereof is in contact with the guide member side surface 8b of the wedge member 8.

According to the fifth embodiment, since the respective outer races of the radial bearings 70 rotate according to the movement of the wedge member 8, a frictional resistance between the wedge member 8 and the piston 5 or the guide member 10 is reduced so that the wedge member 8 can move smoothly. Further, at least three pieces of the radial bearings 70 serve to keep the wedge member 8 moving along the piston 5 and guide member 10 at a predetermined angle.

More than two radial bearings 70 and more than one radial bearing 70 may be fixed to and held by the piston 5 and the guide member 10, respectively.

(Sixth Embodiment)

A disk brake according to sixth embodiment has column shaped rollers 71 and radial bearings 72 provided in the piston 5 and the guide member 10 instead of the first and second roller bearings 14 and 15 of the first embodiment.

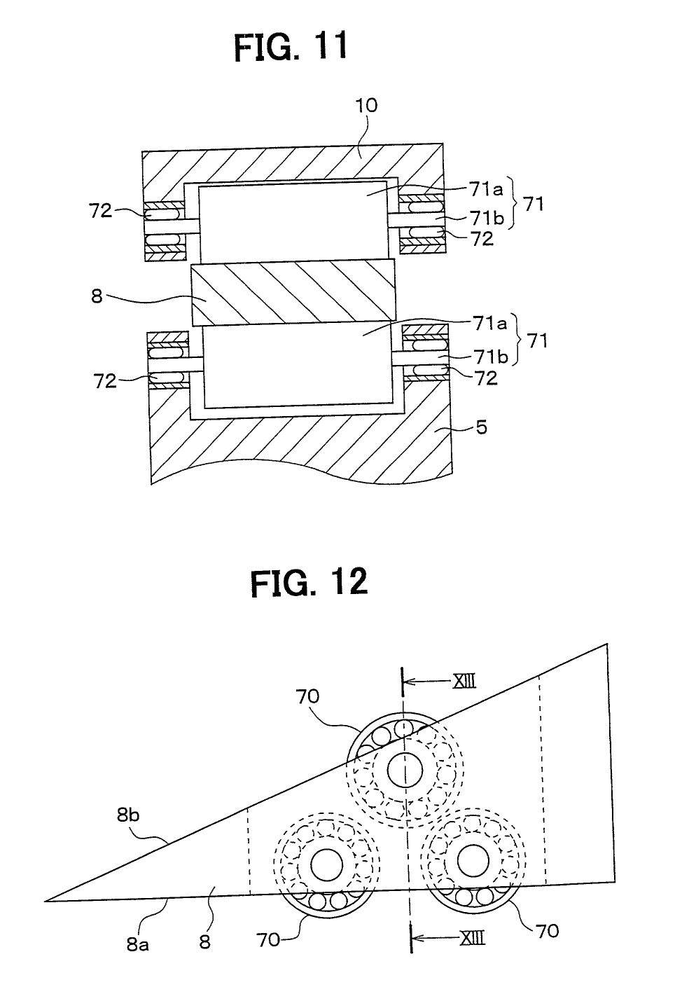

As shown in FIGS. 10 and 11, two rollers 71 and one roller 71 are fixed and held via the radial bearings 72 by the piston 5 and the guide member 10, respectively. Each of the rollers 71 is composed of a large diameter column portion 71a and a small diameter column portion 71b.

Each small diameter column portion 71b of the two rollers 71 is inserted into and held by each of the radial bearings 72 fixed to the piston 5 and each large diameter portion 71a thereof is in contact with the piston side surface 8a of the wedge member 8. The small diameter column portion 71b of the one roller 71 is inserted into and held by the one radial bearing 72 fixed to the guide member 10 and the diameter portion 71a thereof is in contact with the guide member side surface 8b of the wedge member 8.

According to the sixth embodiment, since the respective rollers 71 rotate according to the movement of the wedge member 8, a frictional resistance between the wedge member 8 and the piston 5 or the guide member 10 is reduced so that the wedge member 8 can move smoothly. Further, at least three pieces of the rollers 71 serve to keep the wedge member 8 moving along the piston 5 and guide member 10 at a predetermined angle.

More than two rollers 71 and more than one roller 71 may be fixed to and held by the piston 5 and the guide member 10, respectively.

(Seventh Embodiment)

A disk brake according to seventh embodiment has radial bearings 70 provided in the wedge member 8 instead of the first and second roller bearings 14 and 15 of the first embodiment.

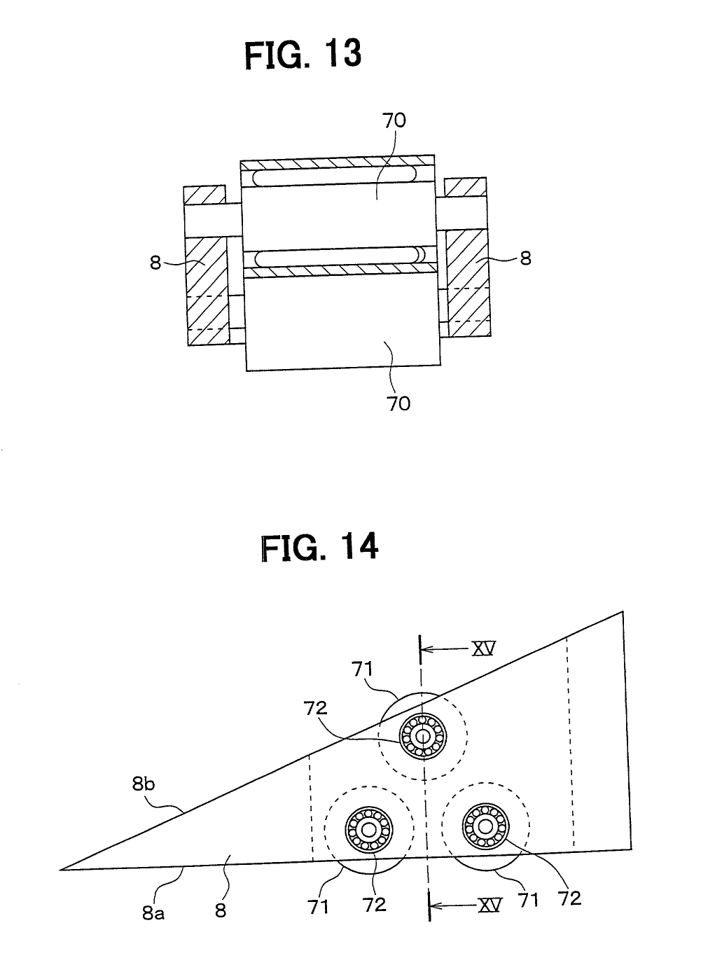

As shown in FIGS. 12 and 13, three radial bearings 70 are fixed to and held by the wedge member 8. Each of the radial bearings 70, which is of well known type, has a cylindrical inner race, a cylindrical outer race and a plurality of balls or rollers between the inner and outer races.

Each outer race of the two radial bearings 70 is in contact with the wedge member side surface 5a of the piston. The outer race of the remaining one radial bearing 70 is in contact with the guide member side surface 10a of the guide member 10.

According to the seventh embodiment, since the respective outer races of the radial bearings 70 rotate according to the movement of the wedge member 8, a frictional resistance between the wedge member 8 and the piston 5 or the guide member 10 is reduced so that the wedge member 8 can move smoothly. Further, at least three pieces of the radial bearings 70 serve to keep the wedge member 8 moving along the piston 5 and guide member 10 at a predetermined angle.

(Eighth Embodiment)

A disk brake according to eighth embodiment has column shaped rollers 71 and radial bearings 72 provided in the wedge member 8 instead of the first and second roller bearings 14 and 15 of the first embodiment.

As shown in FIGS. 14 and 15, three rollers 71 are fixed and held via the radial bearings 72 by the wedge member 8. Each of the rollers 71 is composed of a large diameter column portion 71a and a small diameter column portion 71b.

Each small diameter column portion 71b of the rollers 71 is inserted into and held by each of the radial bearings 72 fixed to the wedge member 8. Each large diameter portion 71a of two out of the three rollers 71 is in contact with the wedge side surface 5a of the piston 5 and the large diameter column portion 71a of the remaining one roller 71 is in contact with the wedge member side surface 10a of the guide member 10.

According to the eighth embodiment, since the respective rollers 71 rotate according to the movement of the wedge member 8, a frictional resistance between the wedge member 8 and the piston 5 or the guide member 10 is reduced so that the wedge member 8 can move smoothly. Further, at least three pieces of the rollers 71 serve to keep the wedge member 8 moving along the piston 5 and guide member 10 at a predetermined angle.

(Ninth Embodiment)

A disk brake according to ninth embodiment has first and second roller bearings 20 and 21 fixed to the wedge member 8 instead of the first and second rollers 20 and 21 fixed to the piston 5 and the guide member 10, respectively, in the second embodiment.

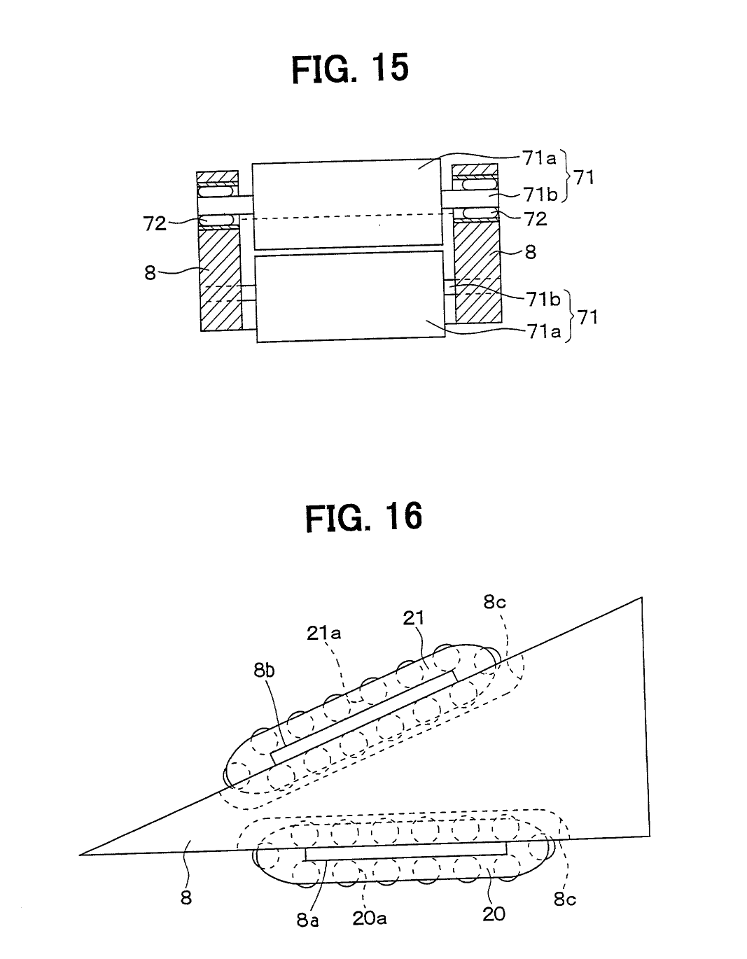

As shown in FIG. 16, the first roller bearing 20 is positioned between the piston 5 and the wedge member 8 and fixed to the wedge member 8, while being partly accommodated in a recess 8c of the wedge member 8. A surface of an orbit base 20c on a side of the piston 5, with which a plurality of rollers 20a are in contact, constitutes the piston side surface 8a of the wedge member 8. The plurality of the rollers 20a in contact with the orbit plate 20c are also in contact with the wedge member side surface 5a of the piston 5.

The second roller bearing 21 is positioned between the wedge member 8 and the guide member 10 and fixed to the wedge member 8, while being partly accommodated in a recess 8c of the wedge member 8. A surface of the orbit base 21c on a side of the guide member 10, with which a plurality of rollers 21a are in contact, constitutes the guide member side surface 8b of the wedge member 8. The plurality of the rollers 21a in contact with the orbit base 21c are also in contact with the wedge member side surface 10a of the guide member 10. When the wedge member 8 is driven, the rollers 20a or 21a circulate, while rolling, around the orbit base 20c or 21c via the recess 5b or 10b along a closed loop path defined by the orbit base 20c or 21c and a pair of side plates 20d or 21d.

According to the ninth embodiment, the force to be transmitted to the piston 5 via the first roller bearing 20 according to the movement of the wedge member 10 is dispersed on the respective rollers 20a so that the force acts uniformly on the wedge member side surface 5a of the piston 5, so a moment of pressing the piston 5 against the wall surface of the cylinder bore 2a is limited, resulting in moving the piston smoothly.

(Tenth Embodiment)

A disk brake according to tenth embodiment has a plurality of radial bearings 70A and 70B instead of the first and second roller bearings of the first embodiment.

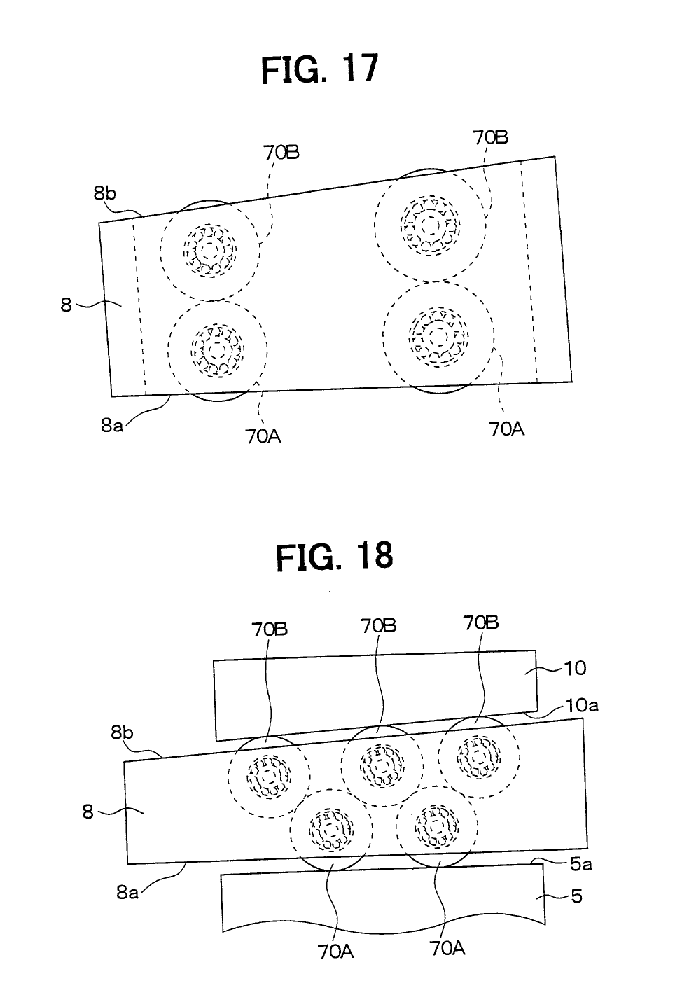

As shown in FIG. 17, two first radial bearings 70A and two second radial bearings 70B are fixed to and held by the wedge member 8. Each of the first and second radial bearings 70A and 70B, which is of well known type, has a cylindrical inner race, a cylindrical outer race and a plurality of balls or rollers between the inner and outer races.

Outer races of the two first radial bearings 70A are in contact with the wedge member side surface 5a of the piston 5. Outer races of the two second radial bearings 70B are in contact with the guide member side surface 10a of the guide member 10. The outer race of the first radial bearing 70A is in contact with the outer race of the second radial bearing 70B.

Further, each diameter of the outer races of the radial bearings 70A and 70B on a left side in FIG. 17 is smaller than that of the outer races of the radial bearings 70A and 70B on a right side in FIG. 17. Due to this diameter difference, a line tangential to outer circumferences of the first radial bearings 70A and a line tangential to outer circumferences of the second radial bearings 70B constitute the tapered angle θ1 of the wedge member 8 (refer to FIG. 3).

According to the tenth embodiment, since the respective outer races of the first and second radial bearings 70A and 70B rotate according to the movement of the wedge member 8, a frictional resistance between the wedge member 8 and the piston 5 or the guide member 10 is reduced so that the wedge member 8 can move smoothly.

To the contrary, unless the outer race of the first radial bearing 70A is in contact with the outer race of the second radial bearing 70B, a reacting force from the piston 5 to each of the first radial bearings 70A acts only on a position where the wedge member 8 holds each of the first radial bearings 70A and a reaction force from the guide member to each of the second radial bearings 70B acts only on a position the wedge member 8 holds each of the second radial bearings 70B.

However, according to the tenth embodiment, since the outer race of the first radial bearing 70A is in contact with the outer race of the second radial bearing 70B, the reacting force from the piston 5 to each of the first radial bearings 70A and the reaction force from the guide member to each of the second radial bearings 70B are counterbalanced with each other so that the forces acting on the positions where the wedge member 8 holds the first and second radial bearings 70A and 70B are limited. Accordingly, each of the first and second radial bearings 70A and 70B is smoothly operative and has a longer life time.

Instead of the arrangement that the respective outer races of the first radial bearings 70A are in contact with the respective outer races of the second radial bearings 70B, one of the outer races of the first radial bearings 70A may be in contact with one of the outer races of the second radial bearings 70B.

(Eleventh Embodiment)

A disk brake according to tenth embodiment has five pieces of radial bearings 70A and 70B instead of the first and second roller bearings of the first embodiment.

As shown in FIG. 18, two pieces of first radial bearings 70A and three pieces of second radial bearings 70B are fixed to and held by the wedge member 8. Each of the first and second radial bearings 70A and 70B, which is of well known type, has a cylindrical inner race, a cylindrical outer race and a plurality of balls or rollers between the inner and outer races.

Outer races of the two first radial bearings 70A are in contact with the wedge member side surface 5a of the piston 5. The outer races of the three second radial bearings 70B are in contact with the guide member side surface 10a of the guide member 10. One of the outer races of the first radial bearings 70A is in contact with two of the outer races of the second radial bearings 70B.

Further, a distance in a direction of the piston axis Y between a line connecting respective centers of the first radial bearings 70A and a line connecting respective centers of the second radial bearings 70B is longer in a right direction in FIG. 18 to constitute the tapered angle θ1 of the wedge member 8 (refer to FIG. 3).

According to the eleventh embodiment, since the respective outer races of the first and second radial bearings 70A and 70B rotate according to the movement of the wedge member 8, a frictional resistance between the wedge member 8 and the piston 5 or the guide member 10 is reduced so that the wedge member 8 can move smoothly.

Further, since the outer races of the first radial bearings 70A are in contact with the outer races of the second radial bearings 70B, the reacting force from the piston 5 to each of the first radial bearings 70A and the reaction force from the guide member to each of the second radial bearings 70B are counterbalanced with each other so that forces acting on positions where the wedge member 8 holds the first and second radial bearings 70A and 70B are limited. Accordingly, each of the first and second radial bearings 70A and 70B is smoothly operative and has a longer lifetime.

(Eleventh Embodiment)

A disk brake according to eleventh embodiment has a construction that the first roller bearing 14 of the first embodiment can move relative to the piston 5 and the wedge member 8 to follow the movement of the wedge member 8.

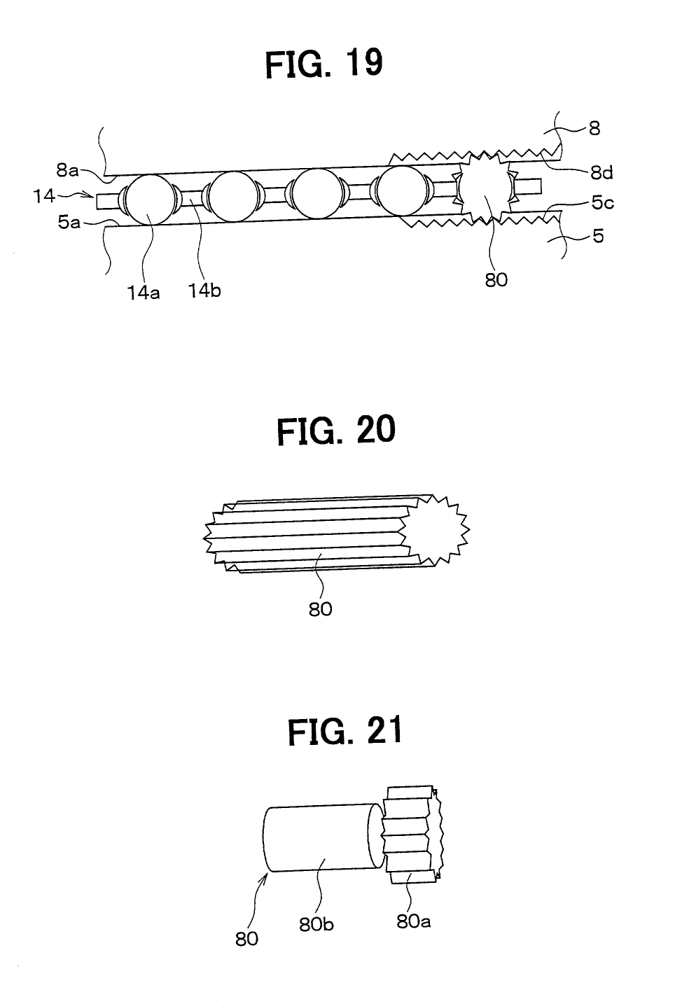

As shown in FIGS. 19 and 20, the first roller bearing 14 disposed between the piston 5 and the wedge member 8 has a plurality of cylindrical or column shaped rollers 14a rotatably held by the holder 14b. A gear 80 whose diameter is larger than that of each roller 14a is also rotatably held by the holder 14b. The wedge member side surface 5a of the piston 5 is provided with a gear portion 5c in mesh with the gear 80 and the piston side surface 8a of the wedge member 8 is provided with a gear portion 8d in mesh with the gear 80. The gear 80 constitutes a displacement transmitting device.

According to the movement of the wedge member 8, the gear 80 in mesh with the gear portions 5c and 5d rotates so that the first roller bearing 14 moves in a moving direction of the wedge member 8 by a half of the moving distance of the wedge member 8.

Since the displacement of the wedge member 8 is transmitted to the first roller bearing 14 by the gear 80 and the gear portions 5c and 5d so that the first roller bearing follows the movement of the wedge member 8 and makes a given movement relative to the wedge member 8 and relative to the piston 5. Accordingly, each of the rollers 14a, through which the force is transmitted from the wedge member 8 to the piston 5, rolls without staying at a position of the wedge member 8.

Further, the gear 80 may be held by the holder 15b of the second roller bearing 15 and each of the guide member side surface 8b of the wedge member 8 and the wedge member side surface 10a of the guide member 10 may be provided with a gear portion in mesh with the gear 80. In this case, the second roller bearing 15 moves to follow the movement of the wedge member 8.

(Thirteenth Embodiment)

A disk brake according to thirteenth embodiment has a gear modified from the gear 80 of the twelfth embodiment.

As shown in FIG. 21, a gear 80, which is the displacement transmitting device, is composed of a gear portion 80a and a column portion 80b. The column portion 80b is rotatably held by the holder 14b and the gear portion 80b, which protrudes out of the holder 14b, are in mesh with the gear portions 5c and 8d (refer to FIG. 19).

According to the movement of the wedge member 8, the gear 80, the gear portion 80a of which is in mesh with the gear portions 5c and 5d, rotates so that the first roller bearing 14 moves in a moving direction of the wedge member 8 by a half of the moving distance of the wedge member 8.

(Fourteenth Embodiment)

A disk brake according to fourteenth embodiment has another construction that the first roller bearing 14 of the first embodiment can move relative to the piston 5 and the wedge member 8 to follow the movement of the wedge member 8.

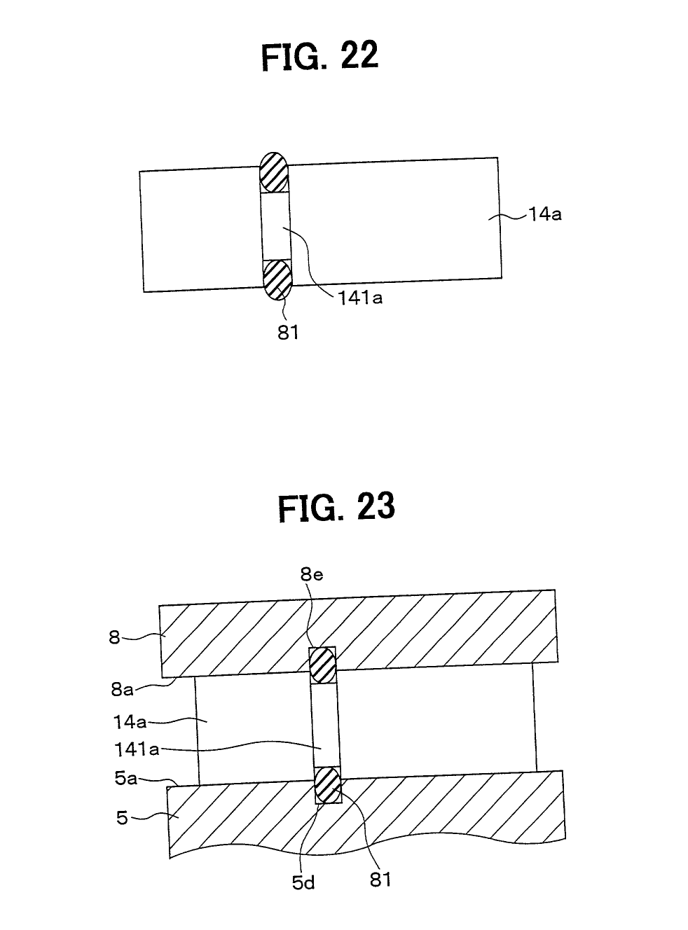

As shown in FIG. 22, each of the rollers 14a of the first roller bearing 14 is provided with an annular groove 141a and a ring 81 is housed in the annular groove 141 to constitute the displacement transmitting device. The ring 81 is in contact with the wedge member side surface 5a of the piston 5 and the piston side surface 8a of the wedge member 8. The ring 81 is made of material, whose coefficient of friction against the wedge member 8 is high, such as rubber.

As the coefficient of friction of the ring 81 against the wedge member 8 is high, there hardly occurs a sliding between the ring 81 and the wedge member 8 so that the displacement of the wedge member 8 is transmitted to the first roller bearing 14 via the ring 81 and the rollers 14a rotate without fail. The first roller bearing 14 moves in a moving direction of the wedge member 8 by a half of the moving distance of the wedge member 8.

Instead of providing the ring 81 in each of the rollers 14a, the ring 81 or the rings 81 may be provided in one of the rollers 14a or some of the rollers. Further, the rollers 15a of the second roller bearing 15 may be provided with a ring 81 or rings 81.

(Fifteenth Embodiment)

A disk brake according to fifteenth embodiment is a modification of the fourteenth embodiment.

As shown in FIG. 23, the wedge member side surface 5a of the piston 5 and the piston side surface 8a of the wedge member 8 are provided respectively with grooves 5d and 8e extending in a moving direction of the wedge member 8. The inner circumferential side of the ring 81 is housed in the groove 141 and opposite ends of the outer circumferential side thereof are engaged with the grooves 5d and 8e, respectively, so that the roller 14a is prevented from shifting in an axial direction thereof.

(Sixteenth Embodiment)

A disk brake according to sixteenth embodiment is another modification of the fourteenth embodiment.

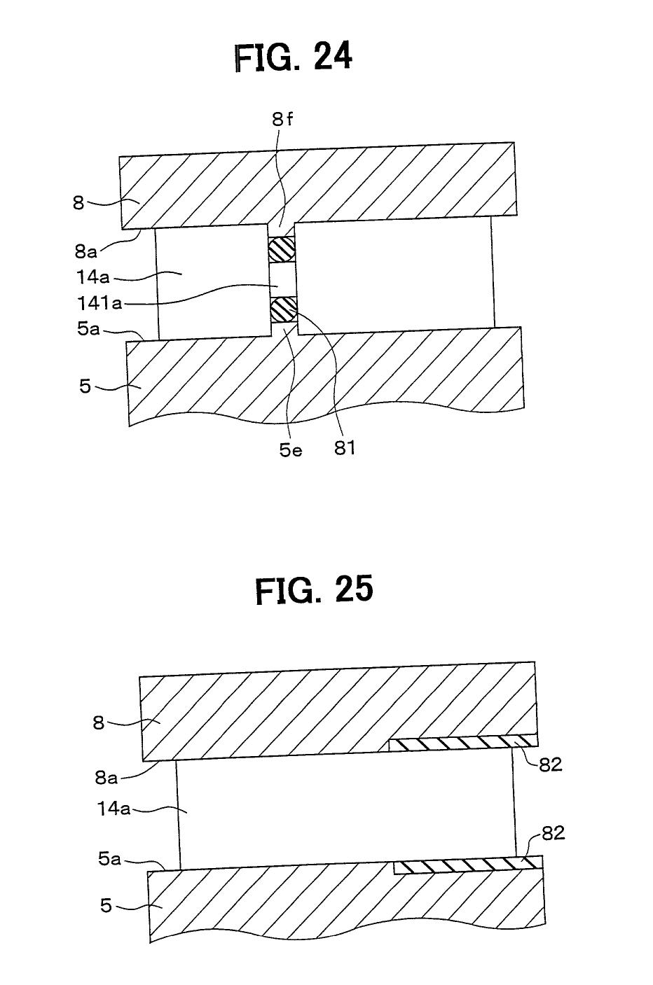

As shown in FIG. 24, the wedge member side surface 5a of the piston 5 and the piston side surface 8a of the wedge member 8 are provided with projections 5e and 8f, respectively, each extending in a moving direction of the wedge member 8. The projections 5e and 8f are engaged with the groove 141a of the roller 14a so that the roller 14a is prevented from shifting in an axial direction thereof.

(Seventeenth Embodiment)

A disk brake according to seventeenth embodiment is a further modification of the fourteenth embodiment.

As shown in FIG. 25, the wedge member side surface 5a of the piston 5 and the piston side surface 8a of the wedge member 8 are provided with baked sheets 82 as the displacement transmitting device, respectively. Each of the sheets 82 is in contact with the rollers 14a of the first roller bearing 14. The sheet 82 is made of material, whose coefficient of friction against the roller 14a is high, such as rubber.

As the coefficient of friction of the ring 81 against the roller 14a is high, there hardly occurs a sliding between the sheet 82 and the roller 14a so that the displacement of the wedge member 8 is transmitted to the roller 14a via the sheet 82 and the roller 14a rotate without fail.

(Eighteenth Embodiment)

A disk brake according to eighteenth embodiment is a further modification of the fourteenth embodiment.

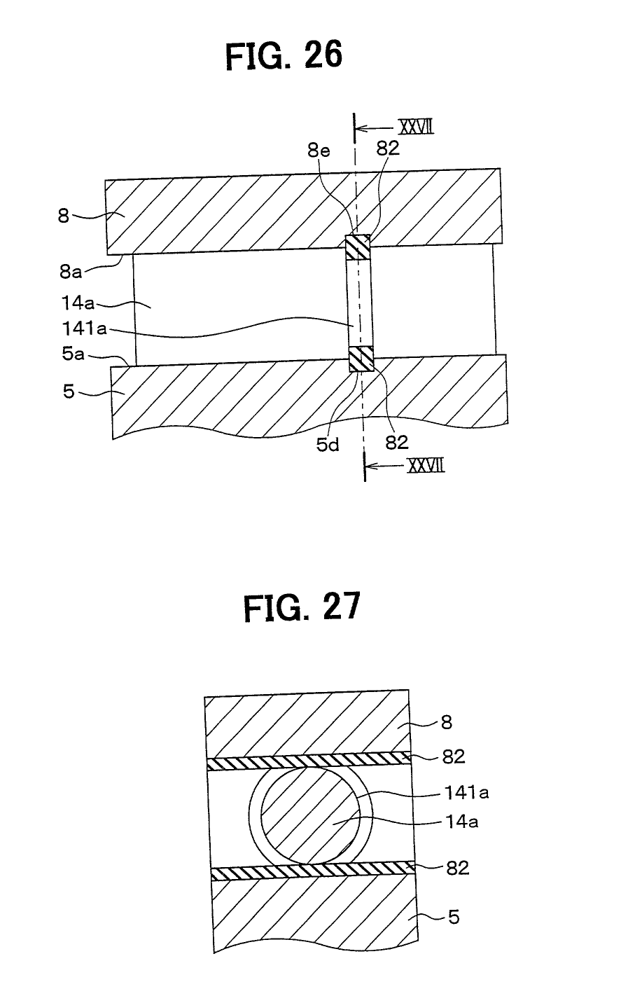

As shown in FIGS. 26 and 27, the wedge member side surface 5a of the piston 5 and the piston side surface 8a of the wedge member 8 are provided with grooves 5d and 8e, respectively, each extending in a moving direction of the wedge member 8. A sheet 82 as the displacement transmitting device is installed by baking in each of the grooves 5d and 8e and a part of the sheet 82 is engaged with the groove 141a of the roller 14a. The sheet 82 is made of material, whose coefficient of friction against the roller 14a is high, such as rubber.

As the coefficient of friction of the ring 81 against the roller 14a is high, there hardly occurs a sliding between the sheet 82 and the roller 14a so that the displacement of the wedge member 8 is transmitted to the roller 14a via the sheet 82 and the roller 14a rotate without fail. Further, since the part of the sheet 82 is engaged with the groove 141a of the roller 14a, the roller is prevented from shifting in an axial direction thereof.

(Nineteenth Embodiment)

A disk brake according to nineteenth embodiment has a construction that the first roller bearing 14 of the first embodiment can move relative to the piston 5 and the wedge member 8 to follow the movement of the wedge member 8.

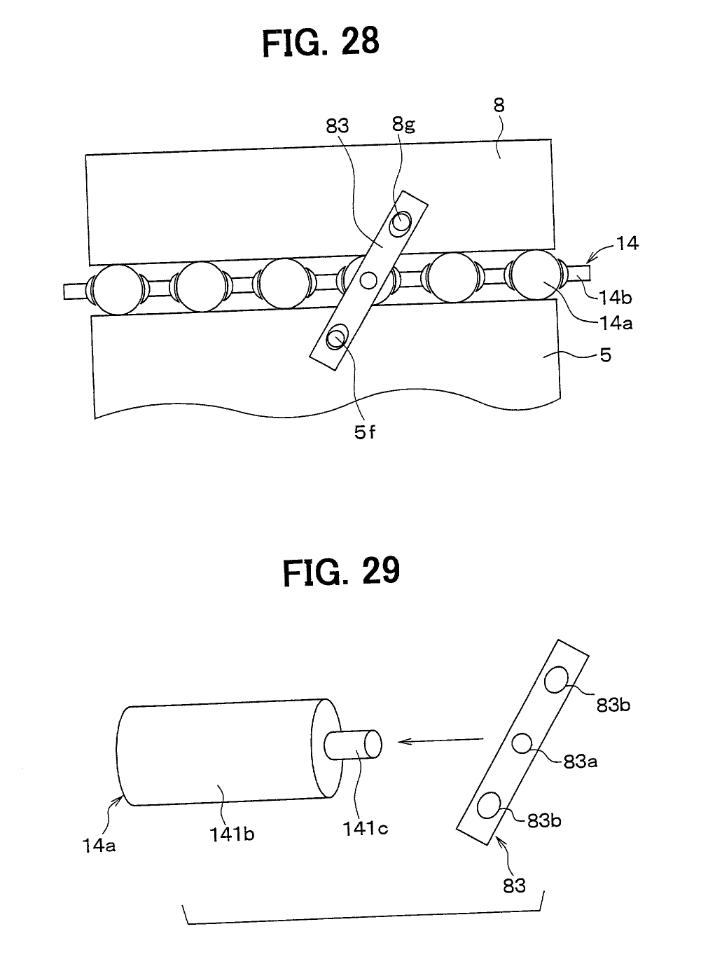

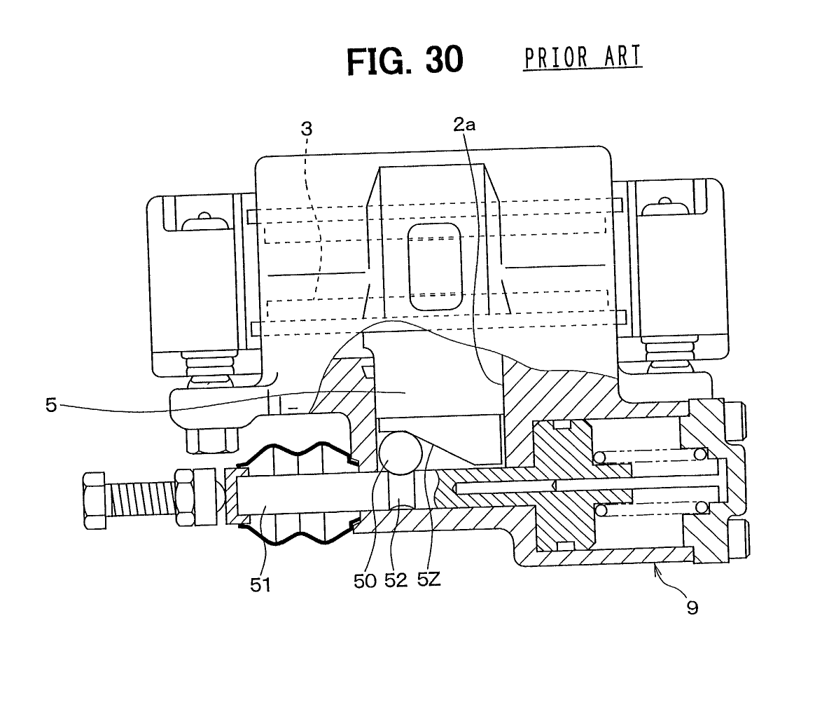

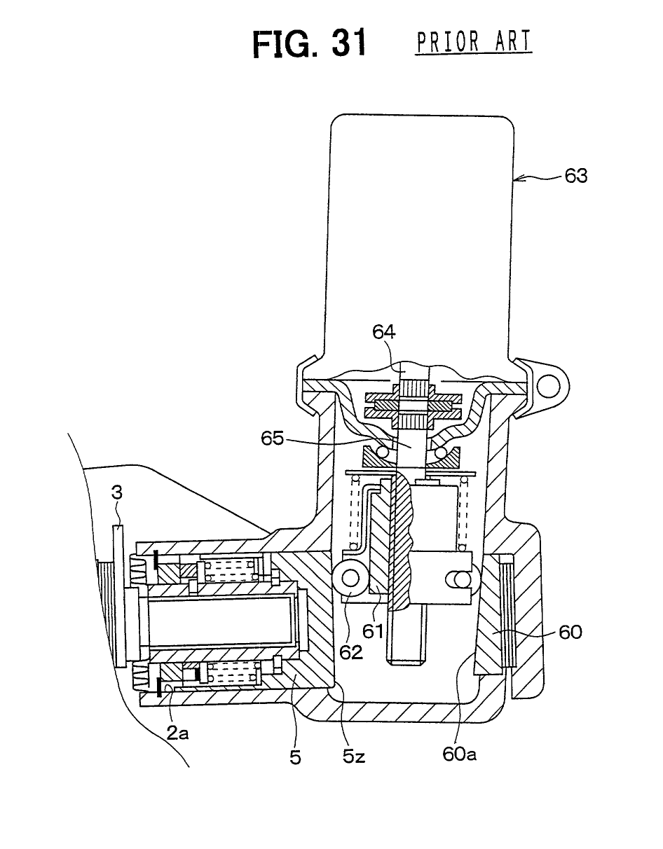

As shown in FIGS. 28 and 29, in the first roller bearing 14 disposed between the piston 5 and the wedge member 8, the plurality of column shaped rollers 14a are rotatably held by the holder 14b. One of the rollers 14a is composed of a large diameter column portion 141b and a small diameter column portion 141c. The large diameter column portion 141b is rotatably held by the holder 14b and the small diameter column portion 141c protrudes out of the holder 14b.

A link 83, which constitutes the displacement transmitting device, is provided in a center thereof with a round hole 83a and at longitudinal opposite end sides with elongated holes 83b. The small diameter column portion 141c is inserted into the round hole 83a and pins 5f and 8g, which are provided in the piston 5 and the wedge member 8, respectively, are inserted into the elongated holes 83b.

When the wedge member 8 moves, the rink 83 pivots about the pin 5f as a fulcrum so that the first roller bearing 14 is moved via the roller 14a that is engaged with the round hole 83a of the rink 83 in a moving direction of the wedge member 8. As mentioned above, the displacement of the wedge member 8 is transmitted to the first roller bearing 14 so that the first roller bearing 14 follows the movement of the wedge member 8 without fail and make a predetermined movement relative to the piston 5 and the wedge member 8.

In any one of the embodiments mentioned above, the drive unit 9 may be a hydraulic device or an electric motor with a speed reduction device.

What is claimed is

1. A disk brake comprising:
a disk to be rotated from outside;
a frictional material whose one surface faces to the disk with a space therebetween;
a bore;
a piston which is movable in the bore and whose axial end surface is connected to the other surface of the frictional material;
a guide member disposed on an opposite side of the disk with respect to the piston;
a wedge member sandwiched between the piston and the guide member, one side surface of the wedge member being in line contact with plural positions of the other axial end surface of the piston that are dispersed on opposite sides of an axis of the piston and the other side surface of the wedge member is in line contact with a surface of the guide member; and
a drive unit for moving the wedge member substantially perpendicularly to an axis of the piston, while allowing the wedge member to float in an axial direction of the piston,
wherein a contact surface between the piston and the wedge member is a plane perpendicular to an axis of the piston and a contact surface between the wedge member and the guide member is a plane being inclined by a given angle to the axis of the piston so that, when the wedge member is driven, the piston moves axially and presses the frictional material against the disk.

2. A disk brake comprising:
a disk to be rotated from outside;
a frictional material whose one surface faces to the disk with a space therebetween;
a bore;
a piston which is movable in the bore and whose axial end surface is connected to the other surface of the frictional material;
a guide member disposed on an opposite side of the disk with respect to the piston;
an arc shaped wedge member sandwiched between the piston and the guide member, one side surface of the wedge member being in line contact with plural positions of the other axial end surface of the piston that are dispersed on opposite sides of an axis of the piston and the other side surface of the wedge member is in line contact with a surface of the guide member; and
a drive unit for rotating the wedge member substantially about a rotating center that is positioned on an extended line of an axis of the piston, while allowing the wedge member to float in an axial direction of the piston,
wherein a contact surface between the piston and the wedge member is an arc surface whose curvature is substantially same as that of the wedge member and whose curvature center is positioned on the extended line of the axis of the piston and a contact surface between the wedge member and the guide member is an arc surface whose curvature center is located on a line being inclined by a given angle to the axis of the piston so that, when the wedge member is driven, the piston moves axially and presses the frictional material against the disk.

3. A disk brake comprising:
a disk to be rotated from outside;
a frictional material whose one surface faces to the disk with a space therebetween;
a bore;
a slide bearing provided in the bore;
a piston which is movable via the slide bearing in the bore and whose axial end surface is connected to the other surface of the frictional material;
a guide member disposed on an opposite side of the disk with respect to the piston;
a wedge member sandwiched between the piston and the guide member, one side surface of the wedge member being in line contact with plural positions of the other axial end surface of the piston that are dispersed on opposite sides of an axis of the piston and the other side surface of the wedge member being in line contact with a surface of the guide member; and
a drive unit for moving the wedge member along a contact surface between the piston and the wedge member and along a contact surface between the wedge member and the guide member so as to make the wedge member a relative movement to the piston and the guide member,
wherein a length of the wedge member in an axial direction of the piston from the contact surface between the piston and the wedge member to the contact surface between the wedge member and the guide member varies in a direction perpendicular to the piston axis so that, when the wedge member is driven, the piston is moved in a direction of pressing the frictional material against the disk.

4. A disk brake according to any one of claims 1 to 3, wherein one of a side surface of the wedge member and the other axial end surface of the piston is provided with a roller bearing having a plurality of rollers in contact with the other of the side surface of the wedge member and the other axial end surface of the piston that constitute the contact surface between the piston and the wedge member.

5. A disk brake according to any one of claims 1 to 3, wherein one of the other side surface of the wedge member and the surface of the guide member is provided with a roller bearing having at least a roller in contact with the other of the other side surface of the wedge member and a surface of the guide member that constitutes the contact surface between the wedge member and the guide member.

6. A disk brake according to any one of claims 1 to 3, wherein one of a side surface of the wedge member and the other axial end surface of the piston is provided with a first roller bearing having a plurality of first rollers in contact with the other of the side surface of the wedge member and the other axial end surface of the piston that constitute the contact surface between the piston and the wedge member and, further, one of the other side surface of the wedge member and the surface of the guide member is provided with a second roller bearing having at least a second roller in contact with the other of the other side surface of the wedge member and a surface of the guide member that constitutes the contact surface between the wedge member and the guide member.

7. A disk brake according to any one of claims 1 to 3, wherein one of a side surface of the wedge member and the other axial end surface of the piston is provided with a first orbit base and a first roller bearing having a plurality of first rollers that circulate on and around the first orbit base to follow a closed loop path and are in contact with the other of the side surface of the wedge member and the other axial end surface of the piston that constitutes the contact surface between the piston and the wedge member and, further,
wherein one of the other side surface of the wedge member and the surface of the guide member is provided with a second orbit base and a second roller bearing having a plurality of second rollers that circulate on and around the second orbit base to follow a closed loop path and are in contact with the other of the other side surface of the wedge member and the surface of the guide member that constitutes the contact surface between the wedge member and the guide member.

8. A disk brake according to claims 1, wherein one of a side surface of the wedge member and the other axial end surface of the piston is provided with at least two pieces of roller shaped first bearings in contact with the other of the side surface of the wedge member and the other axial end surface of the piston that constitutes the contact surface between the piston and the wedge member and, further,
wherein one of the other side surface of the wedge member and the surface of the guide member is provided with at least one piece of roller shaped second bearing in contact with the other of the other side surface of the wedge member and the surface of the guide member that constitutes the contact surface between the wedge member and the guide member.

9. A disk brake according to claims 8, wherein the first and second bearings are held by the wedge member in such a manner that an outer circumferential surface of the second bearing is in contact with at least one of outer circumferential surfaces of the first bearings, while each of the outer circumferential surfaces of the first bearings is in contact with the other axial end surface of the piston and the outer circumferential surface of the second bearing is in contact with the surface of the guide member.

10. A disk brake according to claims 1, wherein at least one of a side surface of the wedge member and the other axial end surface of the piston is provided with a roller bearing having a plurality of rollers in contact with the other of the side surface of the wedge member and the other axial end surface of the piston that constitutes the contact surface between the piston and the wedge member and also provided with a displacement transmission device for forcing the roller bearing to move together with the movement of the wedge member.
